(19) United States
(12) Patent Application Publication
(10) Pub. No.: US 2018/0373613 A1
(43) Pub. Date: Dec. 27, 2018

(54) SYSTEMS AND METHODS FOR GENERATING AND PRESENTING ALTERNATIVE INPUTS FOR IMPROVING EFFICIENCY OF USER INTERACTION WITH COMPUTING DEVICES

(71) Applicant: Lenovo Enterprise Solutions (Singapore) Pte. Ltd., New Tech Park (SG)

(72) Inventors: Srihari Venkata Angaluri, Raleigh, NC (US); Gary David Cudak, Raleigh, NC (US); Ajay Dholakia, Raleigh, NC (US); Michael Albert Perks, Raleigh, NC (US)

(21) Appl. No.: 15/632,301

(22) Filed: Jun. 24, 2017

(51) Int. Cl. G06F 11/34; G06F 3/0481; G06F 9/44; G06F 17/30

(52) U.S. Cl. CPC G06F 11/3438; G06F 3/04812; G06F 17/30905; G06F 9/4443; G06F 11/3476

(57) ABSTRACT

Systems and methods for dynamic user gesture creation are disclosed. According to an aspect, a method includes analyzing, by the processor, a set of inputs of a user into a computing device to achieve a result on the computing device. The method also includes determining, by the processor, whether an efficiency threshold is met if the user utilizes another input to achieve the result rather than the set of inputs. Further, the method includes presenting the other input to the user as an alternative input for achieving the result on the computing device in response to determining that the efficiency threshold is met.

### TECHNICAL FIELD

The presently disclosed subject matter relates to user interaction with computing devices. More particularly, the presently disclosed subject matter to systems and methods for generating and presenting alternative inputs for improving efficiency of user interaction with computing devices.

### BACKGROUND

When using a computing device, users frequently carry out the same sets of actions to garner a certain result. As an example, the user may frequently perform a set of inputs each time the user wants a particular result from the computing device. For example, a user may enter multiple distinct inputs, such as touchscreen gestures, to a smartphone for listening to an audio playlist. The user would need to navigate to the home screen, locate the icon for the audio playlist, select the audio playlist, and press play once the audio playlist has been loaded. Such multi-step actions are time-consuming, tedious and inefficient. Furthermore, the computing device would have to process the multiple distinct inputs each time that the user desires to obtain that particular result (e.g. listening to the audio playlist), thus consuming valuable computing resources.

In addition, the inputs and gestures performed to obtain the result originate from a basic standard set that all users have to use and abide by. Referring again to the example above, a user would have to navigate to the home screen and perform the various actions in order to engage the audio playlist. However, a particular user may have difficulty performing these standard actions. In one example, macular degeneration may make it hard for the user to see the screen and icons. In another example, severe sweatiness might prevent the computing device from properly registering the user's touch on the screen and thus erroneously giving a different result than the one the user desires or even not giving a result at all since the computing device cannot sense the user's touch. As such, standard gestures aren't very useful for users when they cannot properly use them on their computing device to obtain the results that they want.

In view of the foregoing, it is desirable to provide systems and methods for generating and presenting alternative inputs for improving efficiency of user interaction with computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for generating presenting alternative inputs for improving efficiency of user interaction with computing devices. According to an aspect, a method includes analyzing, by the processor, a set of inputs of a user into a computing device to achieve a result on the computing device. The method also includes determining, by the processor, whether an efficiency threshold is met if the user utilizes another input to achieve the result rather than the set of inputs. Further, the method includes presenting the other input to the user as an alternative input for achieving the result on the computing device in response to determining that the efficiency threshold is met.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system for systems and methods for dynamic user gesture creation in accordance with embodiments of the present disclosure;

FIG. 2 is a flow chart of an example method for implementing systems and methods for dynamic user gesture creation in accordance with embodiments of the present disclosure; and

FIG. 3 is a flow chart of an example method for determining when the efficiency threshold is met in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

When using a computing device, it is desirable to have the device tailored to a user's needs based on the user's actions. As an example, the user may frequently perform a set of inputs each time the user wants a result from the computing device (e.g. listening to an audio playlist, etc.). It would be beneficial to have this set of inputs and result associated with an alternative input for expediency and efficiency. The alternative input is a dynamic user gesture based on the user's particular set of inputs for reaching the result. The alternative input can be stored on the computing device, allowing the user to perform the alternative input rather than the set of inputs to reach the result. This leads to a more economical and customizable user experience and enables the computing device to operate faster and more efficiently. Furthermore, the computing device becomes tailored to the user's needs. The present disclosure provides systems and methods for generating and presenting alternative inputs for improving efficiency of user interaction with computing devices.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, a gaming console system (e.g. XBOX®, KINECT®, PLAYSTATION®, or the like). In another example, a computing device may be a smart television that is capable of receiving and transmitting user input, as well as internet connectivity. In another example, a computing device may be an optical head-mounted display device (e.g. GOOGLE GLASS). In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users can interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

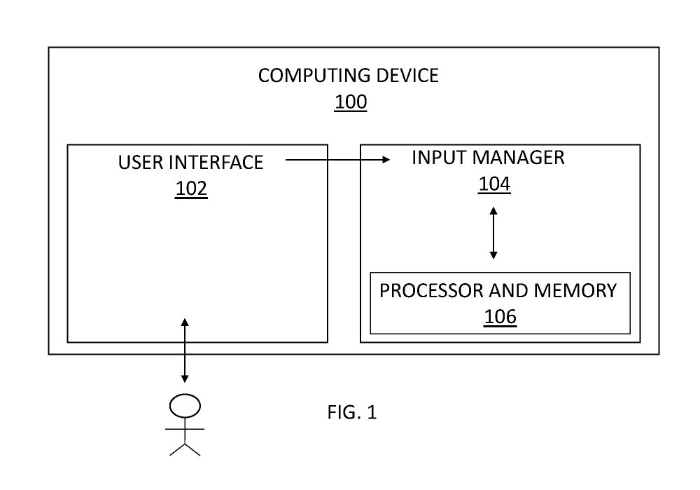

The presently disclosed subject matter is now described in more detail. For example, FIG. 1 illustrates a block diagram of an example system for generating and presenting alternative inputs for improving efficiency of user interaction with computing devices in accordance with embodiments of the present disclosure. Referring to FIG. 1, the system includes a computing device 100 including a user interface 102, an input manager 104, and a processor and memory 106. The computing device 100 may be any suitable computer. In an example, the computing device 100 may be a tablet computer or smartphone. In another example, the computing device 100 may be a gaming console system. In yet another example, the computing device 100 may be a mobile device. In another example, the computing device 100 may be a smart television. In another example, the computing device 100 may be an optical head-mounted display device (e.g., the wearable computer referred to as GOOGLE GLASS™). The computing device 100 may include a user interface 102, such as a display (e.g., touchscreen display), a touchpad, and/or the like. The input manager 104 may receive a set of inputs from the user interface 102 for processing by the processor and memory 106. The input manager 104 may be implemented by hardware, software, firmware, or combinations thereof. The user interface 102 and input manager 104 can used to obtain a result, i.e. state, on the computing device 100. Examples of a state include, but are not limited to: opening an email, playing music, watching a movie, talking on the phone while playing a game, etc. The state is a broad term used to denote possible actions that can be achieved on a computing device 100 by a user.

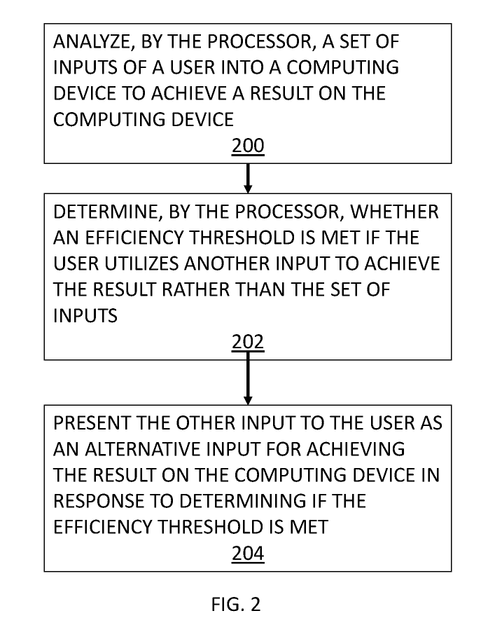

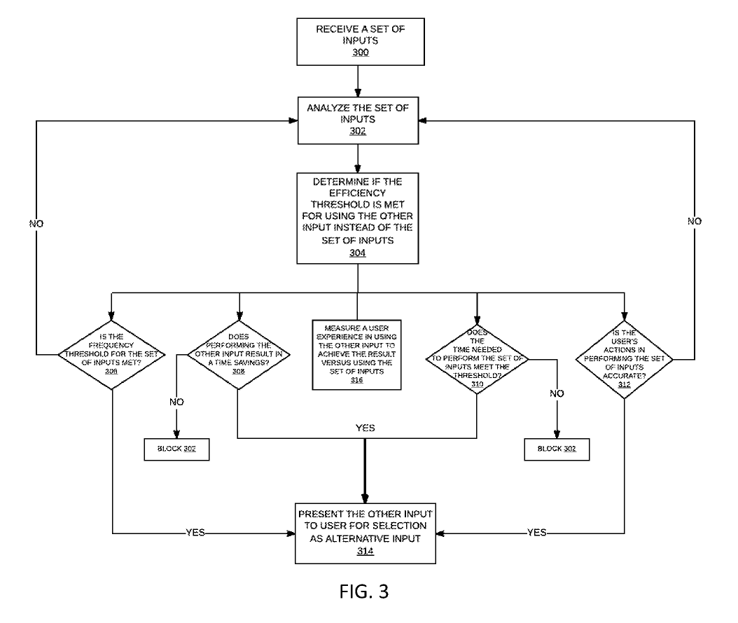

In one example, a user may have a computing device 100 and wish to obtain the result, i.e. state, on the computing device of opening the user's email account. To achieve the result, the user would engage the user interface 102 to reach the home screen and perform the set of inputs into the input manager 104, which then interacts with the processor and memory 106 to analyze the set of inputs and recommend an alternative input (e.g. tap, tap) to obtain the desired result. In another example, the user may wish to use the computing device 100 to obtain the result of opening the user's email while playing music in the background. The user may again engage the user interface 102 and perform the set of inputs into the input manager 104, which then interacts with the processor and memory 106 to analyze the set of inputs and recommend an alternative input (e.g. tap, tap, shake) to obtain the desired results. As shown in FIGS. 2 and 3 below, the use of the alternative input allows the user to achieve the result on the computing device without having to perform the time-consuming step of entering in a set of inputs.

FIG. 2 illustrates a flow chart of an example method for systems and methods for generating and presenting alternative inputs for improving efficiency of user interaction with computing devices in accordance with embodiments of the present disclosure. The method of FIG. 2 is described by example as being implemented by the user interface 102, the input manager 104, and the processor and memory 106 of the computing device 100 shown in FIG. 1, although it should be understood that the method may be implemented by any suitable computing device(s). Further, reference is made to the flow chart shown in FIG. 3 and described in further detail herein in accordance with embodiments of the present disclosure.

Referring to FIG. 2, the method includes analyzing 200 a set of inputs of a user into a computing device 100 to achieve a result on the computing device 100. The result can be a state of and/or action taken by the computing device 100. Example inputs include, but are not limited to, a display swipe, a computing device movement, an audio input, a bodily movement as captured by a computing device 100, a manual depression on a computing device's surface, and the like. For example, the user may interact with the user interface 102 to enter a set of inputs. The entered inputs may be communicated by the user interface 102 to the input manager 104 for analysis. The input manager 104 may analyze the inputs by comparing the set of inputs with an alternative input that may be used to more efficiently achieve a result desired by the user. The alternative input may be presented to the user via the user interface 102. A user may select the alternative input for use in reaching the associated result on the computing device 100.

With continuing reference to FIG. 2, the method includes determining 202 whether an efficiency threshold is met if the user utilizes another input to achieve the result rather than the set of inputs. FIG. 3, as subsequently described, provides details of an example of the determining step 202.

Now referring to FIG. 3, the figure illustrates a flow chart of an example method for determining if the efficiency threshold has been met for using the other input, i.e. the alternative input. The method includes receiving 300 a set of inputs, analyzing 302 the set of inputs, determining 304 if the efficiency threshold is met for using the other input instead of the set of inputs, and presenting 314 the other input to the user for selection as an alternative input. In one example, the computing device 100 must determine if the frequency threshold 306 for the set of inputs is met. If yes, then the efficiency threshold 304 is met and the computing device 100 can present 314 the other input to the user for selection as an alternative input. If no, then the computing device 100 must again analyze 302 the set inputs. In another example, the computing device 100 must determine if performing 308 the other input results in a time savings for the user. If yes, then the efficiency threshold 304 is met and the computing device 100 can present 314 the other input to the user for selection as an alternative input. If no, then the computing device 100 must again analyze 302 the set inputs. In another example, the computing device 100 measures 316 a user experience in using the other input to achieve the result versus using the set of inputs in order to determine if the efficiency threshold 304 is met. In another example, the computing device 100 must determine if the time needed 310 to perform the set of inputs meets the threshold. If yes, then the efficiency threshold 304 is met and the computing device 100 can present 314 the other input to the user for selection as an alternative input. If no, then the computing device 100 must again analyze 302 the set inputs. In another example, the computing device 100 must determine if the user's actions 312 in performing the set of inputs is accurate. If yes, then the efficiency threshold 304 is met and the computing device 100 can present 314 the other input to the user for selection as an alternative input. If no, then the computing device 100 can again analyze 302 the set inputs.

Referring again to FIG. 2, the method includes presenting 206 the other input to the user as an alternative input for achieving the result on the computing device 100 in response to determining that the efficiency threshold 202 is met. In one example, the user accepts the alternative input via the user interface 100, prompting the processor and memory 106 to associate the alternative input with the result and to store the alternative input and the result for use as an input to a user interface 102 of the computing device 100 to achieve that result. In another example, the user rejects the alternative input via the user interface 102, prompting the processor and memory 106 to present another result for association with the set of inputs.

In accordance with the embodiments of the present disclosure, the input manager 104 can generate an alternative input for achieving the result on the computing device 100. In one example, the alternative input may be generated based on determining that the efficiency threshold 202 for the set of inputs has been met. In another example, the alternative input is generated based on a frequency 306 of using the set of inputs to achieve the result. In another example, the alternative input is generated based on determining that the set of inputs leads to an alternative input for achieving the result on the computing device 100. In another example, another alternative input can be generated for achieving another result on the computing device 100 after the user interface 102 receives the user rejection of a presented input 204. Upon generation, the other alternative input is presented to the user for selection.

Referring now to the previous example of a user desiring the result of opening the user's email while playing music in the background: the user initially inputs a set of inputs into the input manager 104 via the user interface 102 of the computing device 100. The input manager 104 may subsequently send the set of inputs to the processor and memory 106 for analysis 302 and to determine if the efficiency threshold 304 is met for using the other, i.e. alternative input, instead of the set of inputs. The processor and memory 106 may examine whether the frequency threshold 306 is met or not; whether performing the other input results in a time savings 308 or not; whether the time 310 needed to perform the set of inputs meets the threshold or not; and whether the user's actions 312 in performing the set of inputs is accurate or not. The processor and memory 106 may also measure 316 the user experience in using the other input to achieve the result versus using the set of inputs. This determination of the efficiency threshold 304 criteria ensures that the other input being presented 314 to the user is one that improves the user environment and operation of the computing device 100 and processor and memory 106. The processing speed of the processor and memory 106 and storage capacity is improved since the user can input the alternative input and achieve the desired result without having to input a set of inputs, consuming time, storage, speed and operating resources. Thus, once the efficiency threshold 304 criteria is satisfied, the processor and memory 106 will generate and present the other input (e.g. tap, tap, shake) to the user for selection. If the efficiency threshold 304 criteria is not satisfied, then the set of inputs is analyzed 302 again to determine another input, i.e. yet another alternative input. If no other alternative input is obtained after some iteration, then the analysis can terminate and the set of inputs may be used to achieve the result on the computing device.

Upon being presented with the other input (e.g. tap, tap, shake), the user can accept the other input or reject it via the user interface 102. When the acceptance is received by the input manager 104 from the user interface 102, the processor and memory 106 will associate the other input (e.g. tap, tap, shake) with the result (e.g. opening the user's email while playing music in the background) and store the other input and the result for use as input to the user interface 102 of the computing device 100 to achieve the result. Alternatively, when the rejection is received by the input manager 104 from the user interface 102, the processor and memory 106 will seek to generate and present an another input, i.e. yet another alternative input, for the user. To generate the another input, the processor and memory 106 will determine if the efficiency threshold 304 for the set of inputs has been met or not; if a frequency of using the set of inputs to achieve the result has been met or not; and if the set of inputs leads to the another input for achieving the result on the computing device. If this criteria is not met, then the set of inputs is again analyzed 304 to determine the other input, i.e. yet another alternative input. If no other alternative input is obtained after some iteration, then the analysis may terminate and the set of inputs may be used. If this criteria is met, then another alternative input is presented 314 to the user which will lead to a different result. For example, the another alternative input could be tap, tap, tap, which would have a result of launching a fitness app along with a movie app rather than the original tap, tap, shake which gives the result of opening the user's email while playing music in the background. The user then again decides to accept or reject the another input via the user interface 102.

In this manner, the computing device 100 becomes tailored to the user's needs and usage because it has learned to recognize the set of inputs for achieving a certain result on the computing device 100 and associate that set of inputs with an alternative input, thereby improving the operating efficiency, functionality, speed and storage of the computing device 100 and processor and memory 106. Furthermore, the alternative input generated is tailored to a particular user since users' inputs provide the basis for generating the alternative input based on the criteria previously set forth. This provides an improvement upon the current method of obtaining results on a computing device 100 because currently, results are obtained using basic standard gestures, while the example embodiment described herein provides generation and usage of dynamic gestures created by and based upon the particular user's inputs.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
analyzing, by the processor, a set of inputs of a user into a computing device to achieve a result on the computing device;
determining, by the processor, whether an efficiency threshold is met if the user utilizes another input to achieve the result rather than the set of inputs; and
in response to determining that the efficiency threshold is met, presenting the other input to the user as an alternative input for achieving the result on the computing device.

2. The method of claim 1, wherein the result is a state on the computing device.

3. The method of claim 1, wherein analyzing the set of inputs comprises comparing the set of inputs with another alternative input to achieve the result, and
wherein the method further comprises presenting the alternative input to a user for selection.

4. The method of claim 1, wherein determining whether an efficiency threshold is met comprises evaluating user accuracy in performing the set of inputs.

5. The method of claim 1, wherein determining whether an efficiency threshold is met comprises evaluating a time needed by a user to perform the set of inputs.

6. The method of claim 1, wherein determining whether an efficiency threshold is met comprises evaluating a time savings by performing the other input rather than the set of inputs.

7. The method of claim 1, wherein whether an efficiency threshold is met comprises measuring a frequency of using the set of inputs to achieve the result.

8. The method of claim 1, wherein determining whether an efficiency threshold is met comprises measuring a user experience in using the other input to achieve the result versus using the set of inputs.

9. The method of claim 1, further comprising:
receiving user input to accept the other input; and
in response to receiving the user input to accept the other input:
associating the other input with the result; and
storing the other input and the result for use as input to a user interface of the computing device to achieve the result.

10. The method of claim 1, further comprising:
receiving user input to reject the result associated with the other input; and
in response to receiving the rejection, presenting another result for association with the set of inputs.

11. The method of claim 1, further comprising generating an alternative input for achieving the result on the computing device based on determining that the efficiency threshold for the set of inputs has been met.

12. The method of claim 1, further comprising generating an alternative input for achieving the result on the computing device based on a frequency of using the set of inputs to achieve the result.

13. The method of claim 1, further comprising generating an alternative input for achieving the result on the computing device based on determining that the set of inputs leads to an alternative input for achieving the result on the computing device.

14. The method of claim 1, further comprising:
generating another alternative input for achieving another result on the computing device after receiving a user rejection of a presented input; and
presenting another alternative input to a user for selection.

15. The method of claim 1, further comprising receiving the set of user inputs via a user interface on the computing device.

16. The method of claim 1, wherein a user input comprises one of a display swipe, a computing device movement, an audio input, a bodily movement as captured by a computing device, and a manual depression on a computing device's surface.

17. The method of claim 1, wherein a computing device comprises one of a computer, a tablet computer, a mobile device, a gaming console system, a smart television, and an optical head-mounted display device.

18. A computing device comprising:
a user interface; and
an input manager comprising at least one of a processor and memory to:
analyze a set of inputs of a user into a computing device to achieve a result on the computing device;
determine whether an efficiency threshold is met if the user utilizes another input to achieve the result rather than the set of inputs; and
present the other input to the user as an alternative input for achieving the result on the computing device in response to determining that the efficiency threshold is met.
